(19) United States
(12) Patent Application Publication
(10) Pub. No.: US 2017/0107710 A1
(43) Pub. Date: Apr. 20, 2017

(54) Portable Waste Maceration System and Apparatus

(71) Applicant: Jack R. Terrazas, San Antonio, TX (US)

(72) Inventor: Jack R. Terrazas, San Antonio, TX (US)

(21) Appl. No.: 14/883,065

(22) Filed: Oct. 14, 2015

(51) Int. Cl. E03D 9/10; E03D 5/012; B60R 15/00; E03D 5/01

(52) U.S. Cl. CPC E03D 9/10; E03D 5/01; E03D 5/012; B60R 15/00

(57) ABSTRACT

A portable human and fibrous waste maceration and disposal system comprising a receiver vessel, a macerator and portable holding tank. Optionally it will be mounted on wheels or adapted for mounting on a removable cart. In some embodiments it will be a single multi-component system and in others a collection of units with detachable holding tank(s). Operation may be automated.

### CROSS REFERENCE TO RELATED APPLICATIONS

This application claims benefit of Provisional Application Ser. No. 62/220,871 filed Sep. 18, 2015, the contents and disclosures of which is incorporated herein by reference in its entirety for all purposes.

### BACKGROUND

Field of Invention

This invention relates to disposable of bulk waste. Specifically it discloses a device and system for disposal of human waste and associated molded pulp paper products.

Background

There are many patented devices for maceration of human waste mixed with fibrous products such as disposable bed pans. The need for such devices is well documented in patents, published applications and the literature. See, for example, published application WO2009/060187, the background disclosure of which is incorporated herein by reference. Published application US 2010/0155514 describes a macerator system for disposal of fibrous waste. It is one of a series of application assigned to Vernacare, Ltd., (see web site vernacare.com) a company specializing in human waste disposal within health care facilities. The system described is a macerating system that is designed to be connected to a sewer system. Such connection often requires plumping to be available or be specially adapted. For many locations this is not financially practical or even possible (such as in existing multi-floor hospitals or other facilities).

Published application US 2009/0260143 describes a waste receiving device that receives waste as it is produced by an incontinent person being bathed in flowing water. It also is designed to be connected to a drain.

Published application US 2007/0240255 describes a macerating toilet that comprises a toilet bowl having a macerating unit disposed beneath the bowl and discharge to a sewer system. See also WO 1990/003949.

While all these systems address an important patient or nursing need, they generally require having to plumb into a specially adapted sewer connections, which in addition to being costly, also limits their application to a single room or area. As a consequence, they also lack portability, which prohibits multi-room usage.

The present invention is a human waste fibrous maceration system that is portable, that is self-contained with a removable macerated waste holding tank and more easily adapted to hospital, nursing home, home use and the like.

### SUMMARY

The invention is a portable human and fibrous waste maceration and disposal system. The system is comprised of a receiver vessel, a macerator and portable holding tank. Optionally it will be mounted on wheels or adapted for mounting on a removable cart. In some embodiments it will be a single multi-component system and in other a collection of units with detachable holding tank(s).

### DESCRIPTION OF FIGURES

A more complete understanding of the method and apparatus of the present invention may be had by reference to the following detailed description when taken in conjunction with the accompanying drawings, wherein:

FIG. 1 is a schematic view of an embodiment of the invention.

FIG. 2 is another schematic view of an embodiment of the invention with multiple components.

FIG. 3 is a schematic top view of an embodiment of the invention showing holding tanks.

FIG. 4 is a schematic view of a portable holding tank with wheels.

FIG. 5 is a schematic view of another portable apparatus of the invention.

### DETAILED DESCRIPTION

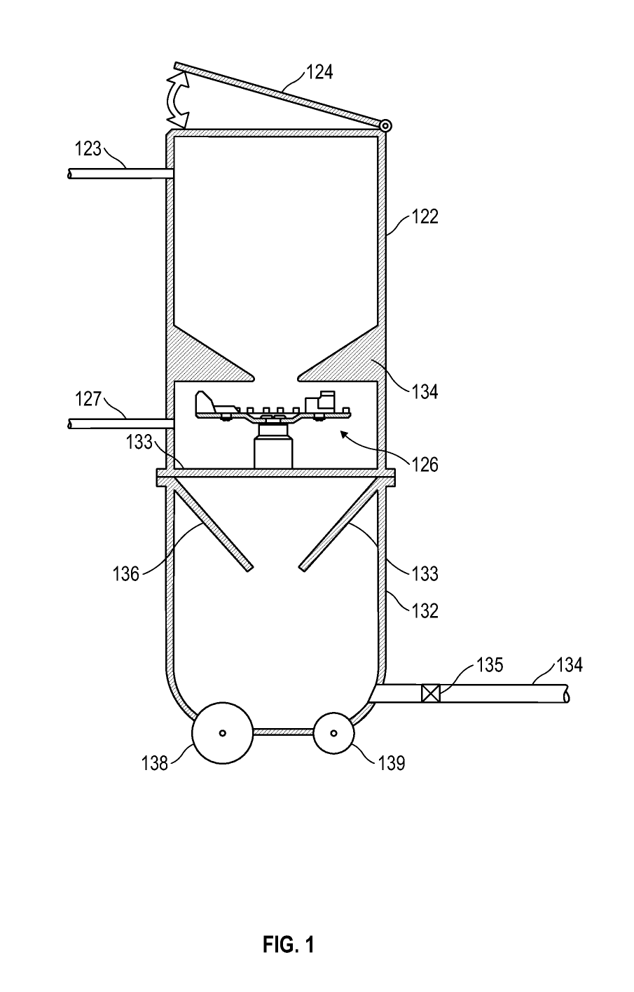

The device and system of this invention is in broad a concept a portable waste and fibrous macerator. It comprises a receiver vessel, macerator and holding tank. Optionally it will be mounted on wheels or adapted for mounting on a movable cart. In some embodiments it will be a single multi-component system and in others multiple units with detachable holding tank(s). Referring to FIG. 1 there is a single unit of an embodiment of the invention. There is a removable receiving tank 122 for receiving waste materials such as disposable fibrous trays, bed pans urinals and the like. These items are usually made of paper or molded pulp products and cannot be disposed in a toilet without maceration. Currently available maceration units are large and not very portable and generally require a special connection to a sewer system. They are not adapted to allow direct disposal of the macerated materials into a toilet. Item 124 of FIG. 1 is a sealable lid, 123 is an inlet conduit for flush water. The lid will preferably be a sealable lid that can be opened and closed by means that do not require the user to touch the lid. This may be by a foot petal activation system or may be totally remote as with a remote control system or WIFI implemented system. Design of such a closure system is within the skill of those in the art. The waste material pass through opening 134 to a macerator unit 126 where the waste is ground to small particles that can be easily disposed of in a residential or hospital toilet sewer system. There are many commercial macerating units that may be adapted for use in this embodiment and in all the systems of this invention. There are commercial units in hospital macerating systems but also in portable waste system like those used in RV unit where it is desirable to macerate the waste to facilitate discharge into sewer systems provided for that service. Generally the macerating unit comprises a blade or blades that cut the solid material into small particles. See for example US 2010/0155514; WO2009/060187; US 2007/0240255 and US 2004/0129807, the relevant disclosures relating to macerating systems are incorporated herein by reference. There is a holding tank 132 to contain the macerated waste. Baffles 136 aid in preventing backflow of macerated waste. Optionally the holding tank is detachable from the maceration unit at point 133 for sterilization, cleaning and the like. But in normal use it will remain attached to the unit above it. The entire unit can be carried to a disposal site (such as a toilet) and the contents discharged through valve 135 and conduit 134. The system will optionally have wheels 138 and 139 to facilitate mobility. There may also be a means such as a sump in the holding tank to transport the macerated waste to disposal.

Conduit 127 allows water wash and flushes and can be used to inject disinfectant. Anti-odor compositions and materials to aid in dissolving the macerated waste matter in the macerator unit and holding tank 132.

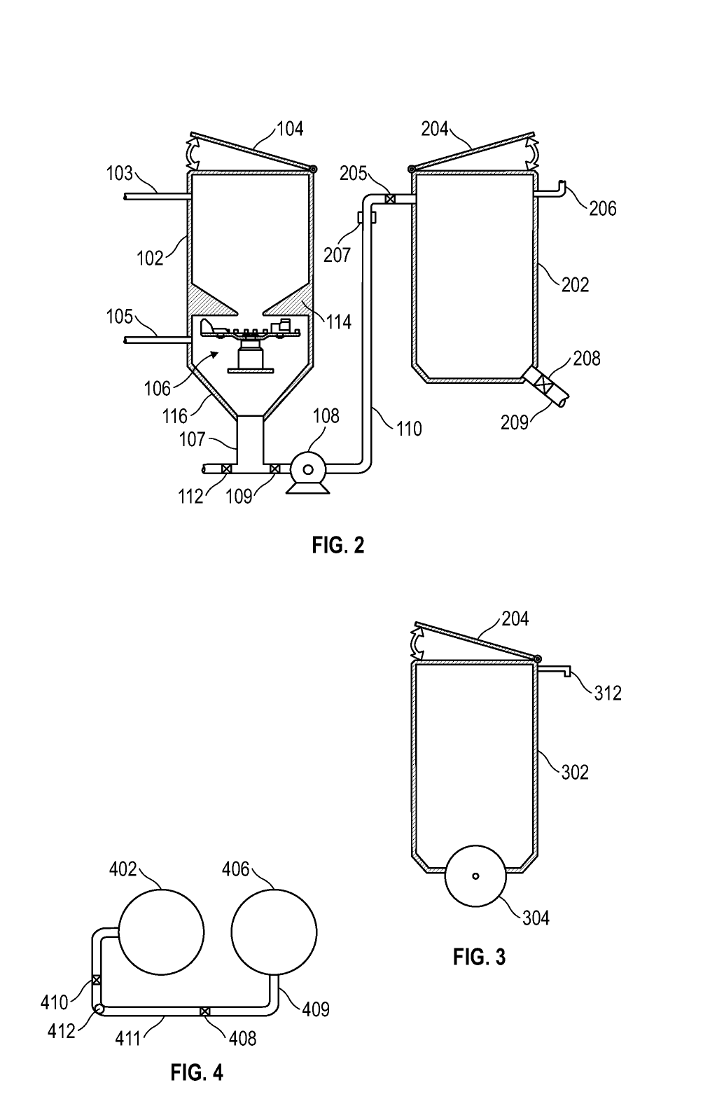

FIG. 2 illustrates another embodiment of the invention. Receiving tank 102 has a sealable lid 104 and water flush conduits 103. Waste material passes through opening 114 to a macerating unit 116. From 106 it passes to the first holding section 116. It is pumped by pump 108 through valve 109 and conduit 110 (also through valve 205) to holding tank(s) 202. Item 112 is a drain valve for 116. Item 206 is a conduit for flushing. Tank(s) 202 have a connector 207 to detach the tank(s) from the unit 102. The holding tank(s) 202 have a valve 208 and drain 209. Optionally it will have wheels as shown in FIG. 3 where the tank(s) 302 rest on wheels 304 and has a handle 312. It may have two wheels as shown or four wheels (optionally two small wheels and two larger wheels). FIG. 4 is a top view of a two holding tank system. Two tanks, 402 and 406, facilitate disposal of one tank without taking the system out of service. Item 410 and 408 are valves in conduit 41 and 412 if top view of a conduit corresponding to 110 in FIG. 2. While it is not apparent in the schematic figure it is contemplated the entire system will be mounted on a frame that optionally will have wheels or other means to easily move it from place to place. It can be mounted on a two wheel “hand truck” like structure that optionally will have means to raise the system to a height for easy disposal of the liquid in the holding tank to a toilet or sewer dump station. For removable holding tanks the frame will be adapted to allow easy removal of the tanks from the frame.

As will be appreciated there will also be an electrical system to operate and control the closures, pumps, macerator motors, etc. These are within the skill of the art but constitute element of the system of the invention.

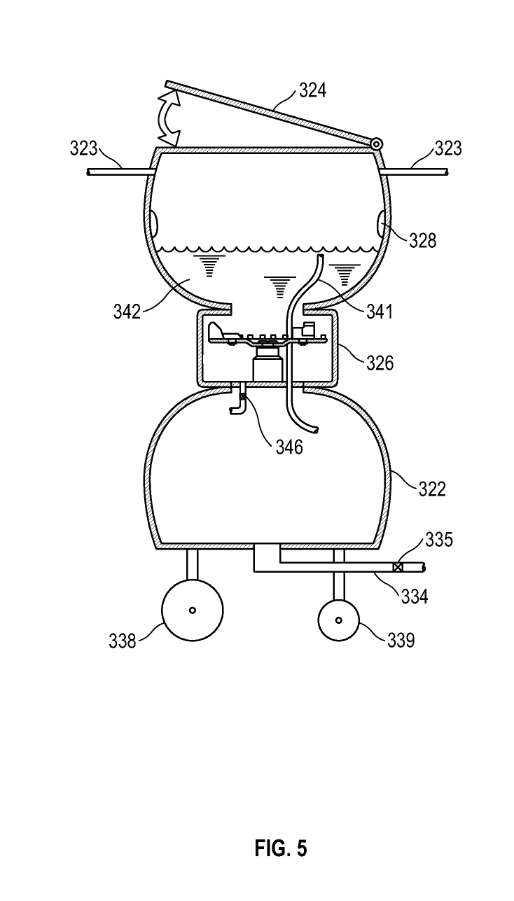

FIG. 5 illustrate yet another embodiment. The receiving tank and holding tanks are, optionally, rounded-bowl like structures. The receiving vessel 328 has a lid 324 and water jets 323 disposed around the circumference of the top section of the receiving tank. These water jet help push the waste into the macerator unit 326. The receiving tank 322 is mounted on a structure with wheel 338 and 339. There is an overflow conduit, 341, that is curved to extend through the macerator into the receiving tank. The bottom of the macerator is sealed but has flush valve 346 to empty its contents into the holding tank. This allows the system to maintain a water level in the receiving tank. The system is preferably automated. Waste such as paper bed pan, urinals and the like are placed in the receiving vessel through the lid 324. The automated system is activated by hand (such as a push button) or by sensors 328 that detect the presence of movement or of an obstruction. Upon activation the lid is closed, jets 323 spray water into the system and the macerator 326 started. After a predetermined time the valve 346 is opened and the liquid contents of the macerator emptied into the holding tank 322. The macerator may be turned off before or after the valve 346 is opened. The overflow conduit 341 ensures that the receiving tank is not overfilled. Design and construction of a suitable automation system is within the capabilities of those skilled in the art.

The system components (vessels and tanks) may be made of any suitable material but it is preferred that the receiving unit and macerator be made of metal and preferably of stainless steel to be able to insure that it can be thoroughly sterilized. The holding tank(s) can be made of metal but polymer materials such as PET, PVC, Polyurethane, Polypropylene, HDPE and the like may be preferable. The holding tank(s) will desirable have a sight glass built in to allow the user to check the liquid level. If the tank is made of polymer a transparent section (strip) may be built into the wall structure.

In this specification, the invention has been described with reference to specific embodiments. It will, however, be evident that various modifications and changes can be made without departing from the broader spirit and scope of the invention as set forth in the appended claims. The terms and expressions employed herein have been used as terms of description and not of limitation; and thus, there is no intent of excluding equivalents, but on the contrary it is intended to cover any and all equivalents that may be employed without departing from the spirit and scope of the invention. The specification is, accordingly, to be regarded in an illustrative rather than a restrictive sense and the scope of the invention should be limited only by the appended claims.

1. A portable waste material maceration and disposal system comprising a receiving vessel placed to discharge into a connected macerating unit that discharges into a holding tank or tanks.

2. The system of claim 1 wherein the system forms one integrated unit.

3. The system of claim 1 wherein the holding tank or tanks are detachable from the receiving vessel and macerating unit.

4. The system of claim 1 wherein the system has wheels for transport.

5. The system of claim 1 wherein the receiving unit has a lid that may be opened, closed and sealed by non-contact means.

6. The system of claim 1 wherein the holding tank has means to determine the liquid level.

7. The system of claim 1 also comprising an automated system for closing a lid on the receiving vessel, activating a water spray jets and opening a flush valve from the receiving vessel to the holding tank.

8. The system of claim 1 also comprising a water source and means for electrical connections.

9. The system of claim 1 wherein there are water jets disposed at a top section of the receiving unit.

10. The system of claim 1 wherein there is an overflow conduit disposed between the receiving unit and holding tank and a remotely activated valve to connect the macerating unit to the holding tank or tanks.
